(19) United States
(12) Patent Application Publication
(10) Pub. No.: US 2001/0009539 A1
(43) Pub. Date: Jul. 26, 2001

(54) Method of data recording

(76) Inventors: Jin Ogasawara, Tokyo-To (JP); Kenji Tsuge, Fujisawa-Shi (JP)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/767,947

(22) Filed: Jan. 24, 2001

(30) Foreign Application Priority Data
Jan. 24, 2000 (JP) 2000-14871

(51) Int. Cl. G11B 7/0045

(52) U.S. Cl. 369/59.25

(57) ABSTRACT

A first area and a second area are allocated in a direction of the radius of a disk-type storage medium. The first area is used for simultaneous recording and reproduction, on which data are sequentially recorded while data that have been recorded thereon are reproduced. The second area is used for regular recording and reproduction, on which data not for the simultaneous recording and reproduction are recorded. Sequential addresses corresponding to the first area are generated. Data for the simultaneous recording and reproduction are sequentially recorded on the first area according the sequential addresses so that the first area becomes a physically continuous area without interposing the second area.

### BACKGROUND OF THE INVENTION

The present invention relates to data recording to rewritable disk-type storage media, such as, optical disks and magnetic disks.

Recording of a live TV-broadcast while viewing to an optically-rewritable disk enables follow-up reproduction when a TV viewer would like to watch the scene broadcast just before or a scene which he or she has missed. This is achieved by simultaneous recording to and reproduction from one optical disk for reproducing already recorded portion while continuously recording a live broadcast.

An recording/reproducing apparatus using one pick-up, after a predetermined period of fast-recording on a recording area of an optical disk, adjusts a disk rotation speed so as to meet the reproduction requirements and also transfers the pick-up onto a reproduction/recording area of the optical disk, for a predetermined period of fast-reproduction. The disk rotation speed is adjusted again so as to meet the recording requirements and the pick-up is transferred back to the recording area for the predetermined period of fast-recording.

Repetition of the fast-recording/reproduction achieves simultaneous recording/reproduction for substantially simultaneously performing recording to and reproduction from one optical disk.

Rewritable optical disks can be used as a video library for TV-program recording in one's absence or dubbing from other equipment.

A recording/reproduction operation for simultaneous recording and reproduction, such as, follow-up reproduction, and for a video library, have no differences for audio/video recording to one optical disk, except that it requires simultaneous recording and reproduction or not.

Such a recording/reproduction operation offers a variety of usage, for example, of an optical disk having two-hour storage capacity at a regular recording rate for a user who wants to have a function of one-hour follow-up reproduction whereas for another user who wants to have a function of forming many libraries while just five-minute follow-up reproduction.

Using all areas of an optical disk for both applications has, however, difficulty in simultaneous recording and reproduction in which a sequential recording area is allocated discontinuously on the optical disk. This could happen, for instance, when re-allocating a low-priority recording area (library) of the optical disk for 60-minute simultaneous recording and reproduction after the recording area of the optical disk has been used for 1 hour and 50 minute-recording as a library.

FIG. 1 illustrates a time chart for such a case. In FIG. 1, the axis of ordinate indicates a location of an optical pick-up on an optical disk 100 in the radius direction; and black and white arrows represent a recording operation to and a reproduction operation from the optical disk, respectively. A circle “A” indicates a continuous recording operation shifted from a position (on the optical disk) at a black arrow L1 where no record-able area has been remaining to another position at a black arrow L2, thus resulting in discontinuous recording positions.

A worst case is such that access areas for simultaneous recording and reproduction are separated on the innermost and outermost areas on the optical disk, as illustrated in FIG. 2.

An optical pick-up moves over positions P1, P2 and P3 on the optical disk 100 while the disk is rotating at a varying rotating speed as illustrated in the timing chart in a constant linear-velocity (CLV) recording/reproduction.

The optical pick-up repeatedly traverses the optical disk 100 for CLV-recording/reproduction operation as described below.

The optical pick-up is located over the outermost position P1 during the term from a moment t1 to a moment t2 for a CLV-recording operation at a disk rotation speed n1.

During the next term from the moment t2 to a moment t3, the optical pick-up moves from the outermost position P1 to the innermost position P3 via a position P2 with increase in disk rotation speed from n1 to n2.

The optical pick-up stops over the innermost position P3 during the term from the moment t3 to a moment t4 for a CLV-reading operation at the disk rotation speed n2.

During the next term from the moment t4 to a moment t5, the optical pick-up moves from the innermost position P3 to the outermost position P1 via the position P2 with decrease in disk rotation speed from n2 to n1.

The optical pick-up then stops over the outermost position P1 during the term from the moment t5 to a moment t6 for a CLV-recording operation at the disk rotation speed n1.

This CLV-recording/reproduction operation requires a buffer for storing a signal to be recorded during a term TSTR from the moments t2 to t6 and also another buffer for storing data that has been read out from the optical disk 100 during a term from the moment t4 to a moment t7 (not shown) thus follows the moment t6, for reproduction.

In other words, this operation takes time from a recording to a reproducing operation due to a large pick-up movement and also a large change in disk rotation speed.

In CLV-recording and reproduction, the disk rotation speed is decreased from the disk-innermost position to the outermost position whereas it is increased from the outermost position to the innermost position during the transition from recording to reproduction and vice versa. The change in disk rotation speed is about 2.4 times (=n2/n1) at the maximum for CDs (Compact Disc) and DVDs (Digital Video Disc).

The CLV-recording/reproduction operation described above requires a large storage-capacity for buffer in temporal data storing on simultaneous recording/reproduction even at preferable recording and reproducing data rates due to a long period of transition between recording and reproduction, thus resulting in increase in cost and delay in operation response in reproduction.

Shortening the period of transition between recording and reproduction requires a short period for a traverse movement of an optical pick-up over the inner and outer peripherals of an optical disk and also a short period of change in rotation speed of a spindle motor for rotating the optical disk.

Also considered for shortening the period of transition between recording and reproduction is a quick change in rotation speed, which, however, requires a powerful motor for driving a spindle motor. This, however, results in high cost and causing problems, such as, generation of heat from the motor and increase in power consumption.

FIG. 3 indicates how much one-round time from recording to reproduction varies according to various requirements in simultaneous recording/reproduction in which recording is performed at the outer periphery whereas reproduction is performed at inner periphery of an optical disk.

The graphs were obtained on the following assumption.

A spindle motor was driven at the maximum torque.

A traverse time for an optical pick-up was neglected because it was always shorter than the time of change in rotation speed of the spindle motor.

There was no loss time in transition of rotation speed of the spindle motor.

The axis of ordinate represents time required for one round. The axis of abscissa represents the number of times for multi-speed fast-reproduction that is obtained as a ratio of reading rate from a storage medium to data output rate.

Curves I, II and III represent change in one-round time at 2.5, 2.75 and 3.00×fast-recording, respectively. The number of times (Cr) for fast-recording is obtained as a ratio of writing rate to a storage medium to data input rate.

It had been expected that the larger the number of times for fast-reproduction, the shorter the time for one round.

However, the curves teach that the time for one round depends on the time for varying a rotation speed of a spindle motor. In other words, the one-round time is short at fast-reproduction with less change in rotation speed of a spindle motor. For example, the curve III teaches that the one-round time is shorter than at reading rate of 3×fast-reproduction or more at 3.00×fast-recording. It is concluded that a small change in rotation speed of a spindle motor is an important factor for shortening the one-round time.

Discontinuous allocation of sequentially recorded portion on an optical disk often causes that a recorded portion for simultaneous recording and reproduction is cut shorter than an expected period, resulting in cumulative time loss; hence requiring increase in buffer-storage capacity or decrease in operation transition time.

### SUMMARY OF THE INVENTION

A purpose of the present invention is to provide a method of recording data on a disk-type storage medium for simultaneous recording/reproduction at relatively low recording and reproduction rates with a small buffer capacity, thus restricting heat and power generated and consumed by a motor for rotating the storage medium.

The present invention provides a method of recording data on a disk-type storage medium.

A first area and a second area are allocated in a direction of the radius of the disk-type storage medium. The first area is used for simultaneous recording and reproduction, on which data are sequentially recorded while data that have been recorded thereon are reproduced. The second area is used for regular recording and reproduction, on which data not for the simultaneous recording and reproduction are recorded. Sequential addresses corresponding to the first area are generated. Data for the simultaneous recording and reproduction are sequentially recorded on the first area according the sequential addresses so that the first area becomes a physically continuous area without interposing the second area.

### BRIEF DESCRIPTION OF DRAWINGS

FIG. 1 illustrates a well-known simultaneous recording and reproduction operation;

FIG. 2 illustrate movement of an optical pick-up over an optical disk and variation in disk-rotation speed in well-known simultaneous recording and reproduction operation;

FIG. 3 indicates variation in one-round time from recording to reproduction in simultaneous recording/reproduction;

FIG. 4 is a block diagram of a preferred embodiment of a recording and reproducing apparatus according to the present invention;

FIG. 5 illustrates recording area-allocation on an optical disk and a simultaneous recording and reproduction operation according to the present invention; and

FIG. 6 indicates variation in ratio of disk-rotation speed or operation time with respect to the relationship between a recording area for simultaneous recording/reproduction and an entire usable area on an optical disk.

### DETAILED DESCRIPTION OF PREFERRED EMBODIMENTS

Preferred embodiments according to the present invention will be disclosed with reference to the attached drawings.

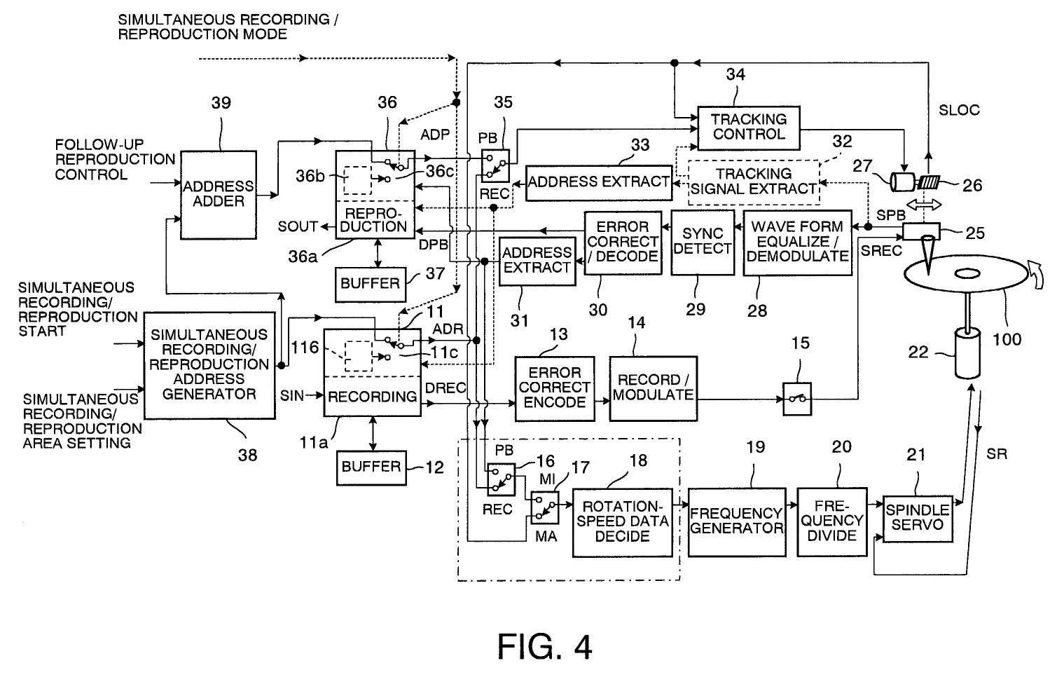

FIG. 4 shows a block diagram of a recording/reproducing apparatus using an optical disk as a preferred embodiment according to the present invention.

This apparatus records video and audio information on an optical disk 100 as digital data and reproduces the stored data, capable of simultaneous recording and reproduction.

A recording system in the apparatus is provided with a recording block 11 having a recording circuit 11a for converting input recording signal SIN that consists of video and audio signals to digital data, and compressing the digital data to output recording data DREC; a buffer 12 for temporarily storing recording data for simultaneous recording and reproduction; an error-correction encoder 13 for performing error correction to the recording data DREC; a recording modulator 14 for modulating the output data of the encoder 13 to a signal SREC to be recorded on the optical disk 100; a switch 15 that is turned on only for recording; and an optical pick-up 25 for recording and reproduction.

The recording block 11 is also equipped with a control interface 11b and a switch 11c. The control interface 11b outputs address information ADR in recording, which will be disclosed later.

A reproduction system in the apparatus is provided with a waveform-equalizing demodulator 28 for equalizing waveforms of a signal SPB read out by the optical pick-up 25 and demodulating the signal SPB; a sync detector 29 for detecting a sync pattern of the output signal of the demodulator 28; an error-correction decoder 30 for performing error correction to the output signal of the detector 29, to output reproduced data DPB; an address extractor 31 for extracting address information involved in the reproduced data DPB; a reproduction block 36 having a reproduction circuit 36a for performing decompression and D/A conversion to the reproduced data DPB, to output a reproduced output signal SOUT; and a buffer 37 for temporarily storing reproduction data during simultaneous recording and reproduction.

The reproduction block 36 is also equipped with a control interface 36b and a switch 36c. The control interface 36b outputs address information ADP in reproduction, which will be disclosed later.

A control system in the apparatus is provided with a switch 35 for switching recording (REC) and reproduction (PB) for the address information; a tracking controller 34 for controlling the position of the optical pick-up 25 according to the address information; a tracking motor 27 for driving the optical pick-up 25; a location encoder 26 for detection the location of the optical pick-up 25; a switch 16 for switching recording (REC) and reproduction (PB) for the address information; a switch 17 for switching micro and macro servo; and a rotation-speed data decider 18 for deciding a rotation speed of the optical disk 100 according to the output of the location encoder 26 in macro servo while to the address information in micro servo.

The control system is also provided with a frequency generator 19 for generating a reference signal having a frequency corresponding to the rotation speed data; a divider 20 for dividing the frequency of the reference signal; a spindle motor 22 for driving the optical disk 100; a spindle servo unit 21 for controlling the rotation speed of the spindle motor 22 in response to rotation information SR that indicates an actual rotation speed of the spindle motor 22, under the output signal of the divider 20; a tracking signal extractor 32 for extracting wamble information from the reproduced signal SPB and an address extractor 33 for extracting address information from the output of the tracking signal extractor 32.

The control system is also provided with a simultaneous recording/reproduction address generator 38 for generating addresses for simultaneous recording/reproduction which will be output as the address information ADR via the switch 11c of the recording block 11; and an address adder 39 for adding addresses for follow-up reproduction to the addresses for simultaneous recording/reproduction, the addition result being output as the address information ADP via the switch 36c of the reproduction block 36. The address generator 36 and the address adder 39 will be disclosed later in detail.

In recording, an input recording signal SIN is converted into a digital signal that is subjected to compression, error correction and modulation processing. The processed signal is recorded on the optical disk 100 via the optical pick-up 25 while the address information ADR carrying recording addresses is sent from the recording block 11 to the rotation-speed data decider 18 via the switches 16 and 17 and also to the tracking controller 34 via the switch 35, for controlling the rotation speed of the optical disk 100 and the position of the optical pick-up 25 according to the recording addresses. The rotation speed of the optical disk 100 is controlled to achieve constant linear velocity according to the location of the optical pick-up 25 over the optical disk 100 in the direction of the disk radius.

In reproduction, an output signal SPB of the optical pick-up 25 is subjected to sync-pattern detection, error-correction/decoding processing. The processed data DPB is sent to the reproduction circuit block 36 for decompression and D/A conversion, to output a reproduced output signal SOUT. The processed data DPB is also sent to the address extractor 31 to extract address information. The address information is also sent to the reproduction circuit block 36 and further to the rotation-speed data decider 18 via the switches 16 and 17.

The address information ADP output by the reproduction block 36 is sent to the tracking controller 34 via the switch 35, for controlling the rotation speed of the optical disk 100 and the position of the optical pick-up 25 according to the addresses of data to be reproduced.

The output signal SPB is also sent to the tracking signal extractor 32 and the address extractor 33 to extract wamble information. The wamble information is sent to the tracking controller 34, the reproduction circuit block 36 and the recording circuit block 11. The tracking signal is used for track control adjustments. The addresses are used as a servo signal for entire control.

The switch 17 is switched to the macro servo (MA)-side in the initial stage of recording and reproduction and is switched to the micro servo (MI)-side as the tracking control is converging.

Disclosed next is simultaneous recording and reproduction.

The simultaneous recording/reproduction mode is set via a user-setting so that the switch 11c of the recording block 11 is turned onto the simultaneous recording/reproduction address generator 38 and also the switch 36c of the reproduction block 36 is turned onto the address generator 39.

A simultaneous recording/reproduction start signal and also simultaneous recording/reproduction area setting signal are supplied to the simultaneous recording/reproduction address generator 38 via a user-setting. The address generator 38 generates sequential addresses which are used as the address information ADR via the switch 11c of the recording block 11.

After a predetermined period of fast-recording on a recording area of the optical disk 100, a follow-up reproduction (fast-reproduction) control signal is supplied to the address adder 39 via a user setting. In response to the control signal, the address adder 39 adds an address value to the present address value for fast-recording to obtain an address that corresponds to the scene that has already been recorded and the user would like to watch now while recording continues. The obtained address is used as the address information ADP via the switch 36c of the reproduction block 36.

The disk rotation speed is adjusted so as to meet the reproduction requirements and then the pick-up 25 is transferred onto a reproduction/recording area of the optical disk 100, for a predetermined period of fast-reproduction. The disk rotation speed is adjusted again so as to meet the recording requirements and the pick-up 25 is transferred back to the recording area for the predetermined period of fast-recording.

Repetition of the fast-recording/reproduction achieves simultaneous recording/reproduction for substantially simultaneously performing recording to and reproduction from one optical disk 100.

FIG. 5 illustrates recorded-data areas over the optical disk 100 by the simultaneous recording/reproduction.

Provided on the optical disk 100 are a first area 101 for simultaneous recording/reproduction and a second area 102 (regular recording area) as a library information storage, for example. The first area 101 is a physically continuous area on which locations of recorded data are sequential in accordance with sequential data. The first and the second areas 101 and 102 are decided by simultaneous recording/reproduction setting (the setting signal being supplied to the simultaneous recording/reproduction address generator 38).

Sequential recording on the first area 101 in simultaneous recording/reproduction is performed as follows:

Sequentially input data are packed in order for each sector to form sector data while sequentially increased-sector numbers are allocated for the sectors. The sector data having monotonously increased-sector numbers are recorded on the first area 101 according to sequential physical addresses indicating the locations on the optical disk 100, that are generated by the simultaneous recording/reproduction address generator 38.

Physical addresses for defective portions (if found previously) on the disk 100 may be skipped to continue the recording. The recording can be performed sequentially on the entire region of the first area 101 even if address skipping happens.

When the optical pick-up 25 reaches an end portion of the first area 101, it jumps onto another end portion to continue the recording. Jumping within the first area 101 from any position to another other than an end portion to another end portion is inhibited. Any intermission occurring during data input or recording forces the next recording to perform from the position just before the position on which the intermission has occurred.

The recording sequence as disclosed above achieves physically sequential recording on the first area 101 in accordance with the order of data input.

Disclosed next is recording on the first area 101 for simultaneous recording/reproduction and the second area 102 that is a regular recording area as a library information storage, for example.

Data to be recorded includes audio or video data, and also information data on identification of these data, addresses on which these data are recorded, and so on.

For the first area 101, the information data includes addresses on the first area 101 on which data for simultaneous recording/reproduction are recorded sequentially as one data.

It is declared in an application program that simultaneous recording/reproduction, for example, follow-up reproduction will be performed. The recording/reproduction apparatus (FIG. 4) allocates the first area 101 only for simultaneous recording/reproduction on the optical disk 100. A file for simultaneous recording/reproduction is composed according to the addresses on the fist area 101, the information data being updated according to the file. The information data will not updated if there is always a file for simultaneous recording/reproduction. The file will be composed after regular data is shifted to the second area 102 if it has been recorded on the first area 101.

Other regular recording data are recorded on the second area 102 separately for each data file, which causes jumping depending on where data files are recorded.

In reproduction, the information data is referred to detect the recorded data for simultaneous recording/reproduction, its addresses, data size, the address on which the next recording will start, and so on.

The simultaneous recording/reproduction can be performed only when the application program generates a command for this mode. The recording is performed with two virtual files for which the file for simultaneous recording/reproduction is separated at a recording start address, each file size being changed dynamically while recording. The reproduction is performed time-sequentially. The simultaneous recording/reproduction is achieved by performing the recording and reproduction by turns while transferring data via buffer.

The first area 101 only for use in simultaneous recording/reproduction and the second area 102 for regular use are set up as disclosed above and used separately according to data types and applications.

Moreover, the first area 101 can be used as a cache area for temporarily storing data for a predetermined period. This data area allocation allows sequential data recording (including overwriting) on the physically sequential area.

When the first area 101 is not used as such a cache area, data that have been recorded on the first area 101 as physically separated from each other can be rewritten sequentially on a sequential empty region that is allocated on the first area 101.

As disclosed above, the simultaneous recording/reproduction achieves sequential recording and reproduction (which are performed by turns) with no intermission, thus avoiding data jump on the first area 101.

Also illustrated in FIG. 5 is the movement of the optical pick-up 25 over the optical disk 100 in simultaneous recording/reproduction. A black arrow BL represents a location of the optical pick-up 25 over the optical disk 100 in the radius direction and a period for recording. A white arrow WL represents a location of the optical pick-up 25 over the optical disk 100 in the radius direction and a period for reproduction.

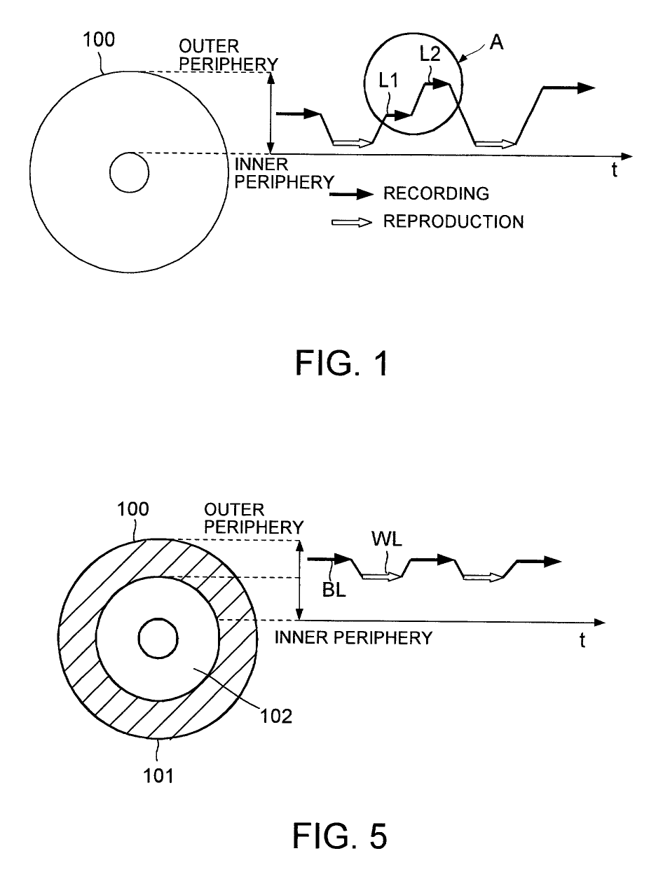

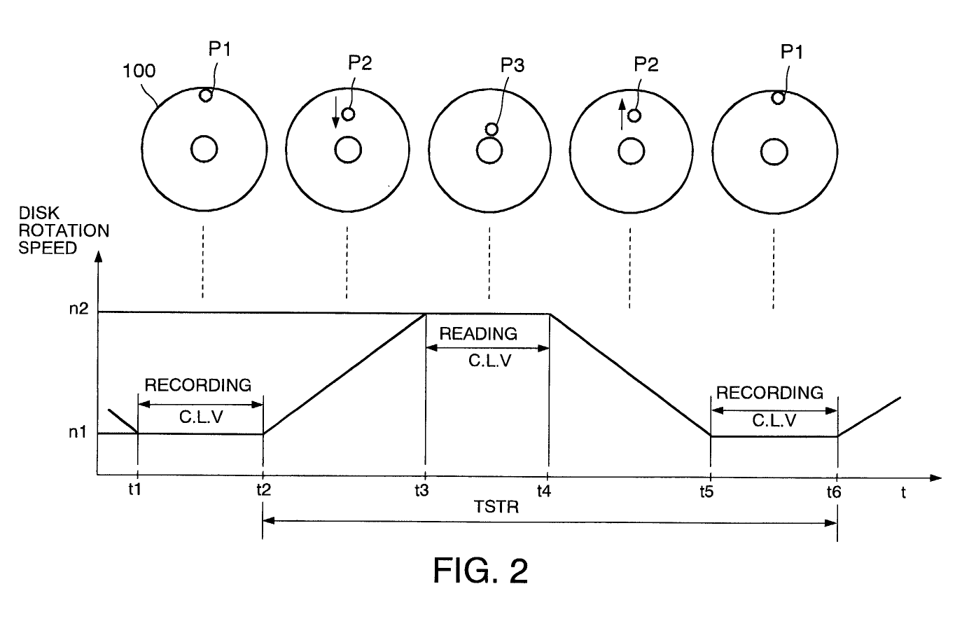

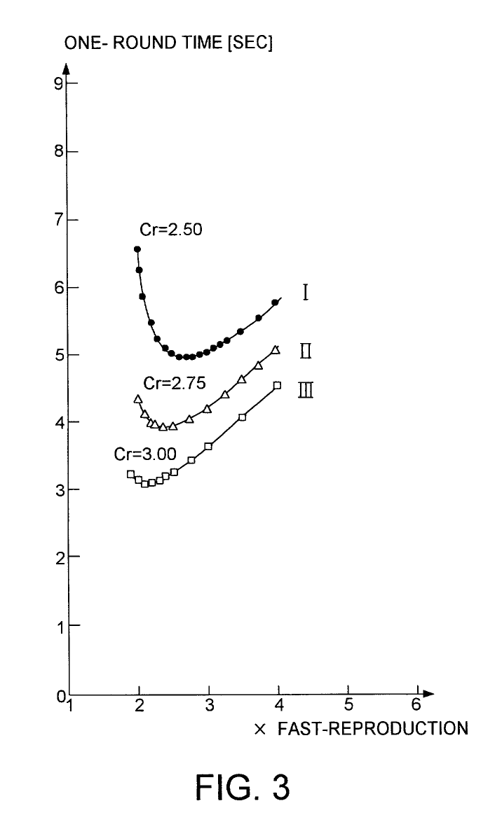

When compared with the illustration in FIG. 1 for well-known apparatus, it is apparent in this invention that the movement of the optical pick-up 25 over the optical disk 100 is little with no discontinuously recorded positions.

Moreover, according to the present invention, the first area 101 only for simultaneous recording/reproduction is allocated on the outermost peripheral side (the area of several tracks including the outermost track) of the optical disk 100, as illustrated in FIG. 5.

This disk-area allocation achieves a transition time between recording and reproduction in simultaneous recording/reproduction shorter than that if the first area 101 is allocated on the inner side of the optical disk 100.

This advantage on disk-area allocation will be discussed in detail.

It was assumed that the first and the second areas 101 and 102 had the equal area on the optical disk 100.

Comparison was made between the following two cases:

(1) The first area 101 was allocated on the outermost side on the optical disk 100. And,

(2) The first area 101 was allocated on the innermost side on the optical disk 100.

The width of the first area 101 for simultaneous recording/reproduction in the radius direction on the optical disk 100 was about 0.4 and 0.6 for the cases (1) and (2), respectively, when the entire width of a usable area is 1, that is, the width for the case (1) was narrower than the case (2).

Moreover, the ratio of disk rotation speed between both ends of the first area 101 in the radius direction on the optical disk 100 was about 1.3:1 and 1.8:1 for the cases (1) and (2), respectively, that is, the ratio for the case (1) was smaller than the case (2).

It is apparent that the case (1) achieves a short distance (time) in movement of the optical pick-up 25 over the optical disk 100 in transition between recording and reproduction in simultaneous recording/reproduction, and also a small variation in disk rotation speed (and a short time for variation in disk rotation speed), for shortening a transition time between recording and reproduction.

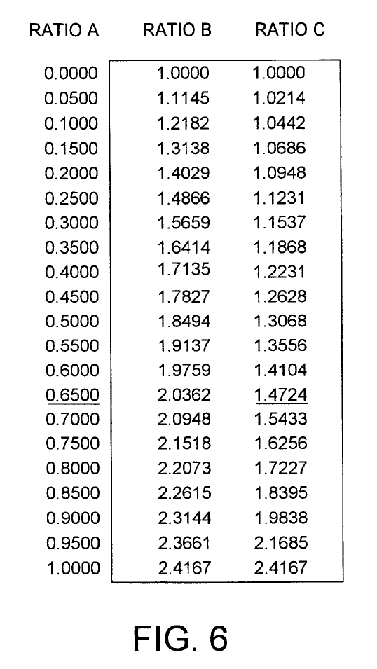

The ratio of disk-rotation speed at the innermost and the outermost regions in the first area 101 was examined as shown in the table in FIG. 6 with respect to a ratio of the first area 101 for simultaneous recording/reproduction to an entire usable area.

In the table, the columns “RATIO A”, “RATIO B” and “RATIO C” indicate as follows:

RATIO A: ratio of the first area 101 to the entire usable area;

RATIO B: the ratio of disk rotation speed variation at the innermost and the outermost regions in the first area 101 at the constant linear-velocity, or the ratio of a reproduction time to a recording time in simultaneous recording/reproduction on the first area 101 at constant disk-rotation speed, when the first area 101 was allocated in the innermost side; and

RATIO C: the ratio of disk rotation speed variation at the innermost and the outermost regions in the first area 101 at the constant linear-velocity, or the ratio of a reproduction time to a recording time in simultaneous recording/reproduction on the first area 101 at constant disk-rotation speed, when the first area 101 was allocated in the outermost side.

As apparent from the table, even if the first area 101 is allocated in the outermost side of the optical disk 100, the maximum ratio of disk rotation speed variation at the constant linear-velocity (RATIO B) increases as the ratio of the first area 101 to the entire usable area (RATIO A) increases, which reaches about 2.4 when RATIO A is 1.000.

Contrary to this present invention achieves simultaneous recording/reproduction in which reproduction is performed while a disk-rotation speed at recording is being kept, or with no variation in disk-rotation speed between recording and reproduction with no overload on the spindle motor. The ratios “RATIO B” and “RATIO C” in FIG. 6 are represented as a ratio of a reproduction time to a recording time as defined above.

For example, when a ratio of operation time between recording and reproduction is 2.1, one-round time for recording and reproduction cannot be less than 3.1 (=a recording time 1.0+a reproduction time 2.1), which corresponds to 3.1×first-recording or more, thus inoperative at 2.5×first-recording, for example.

A standard fast-recording for phase-change optical disks is 2×fast-recording and the maximum is 2.5×fast-recording in general.

Values in “RATIO C” of FIG. 6 that meet this requirement are less than 1.5 (a recording time 1.0+a reproduction time 1.5=2.5).

It is concluded from FIG. 6 that the present invention achieves simultaneous recording/reproduction with no variation in disk-rotation speed by using an area of 65% or less to the entire area of the optical disk 100 as the first area 101.

A reproduction speed can be increased for varying a rotation speed of the spindle motor, even if a recording rate is less than 2×first-recording.

It is further understood by those skilled in the art that forgoing description is a preferred embodiment of the disclosed device and method that various changes and modifications may be made in the invention without departing from the spirit and scope thereof.

For example, as for a disk-type storage medium, not only an optical disk, the present invention is applicable to recording/reproducing apparatus using a magneto-optical disk and a magnetic disk (hard disk), etc.

A typical data form to be recorded on a disk-type storage medium according to the present invention is a time-series sequential data, such as, audio and video as disclosed, however, other form of data is applicable.

According to the recording method of the present invention, the recording area of a disk-type storage medium is divided into a first area and a second area in a direction of the radius of the storage medium. The first area is used for simultaneous recording and reproduction, on which data are sequentially recorded while data that have been recorded thereon are reproduced. The second area is used for regular recording and reproduction, on which data not for the simultaneous recording and reproduction are recorded.

The present invention, therefore, achieves a small movement of a pick-up, such as, an optical pick-up and a magnetic head over the storage medium during simultaneous recording and reproduction, thus restricting heat and power generated and consumed by a motor for rotating the storage medium.

What is claimed is:

1. A method of recording data on a disk-type storage medium, comprising the steps of:
allocating a first area and a second area in a direction of the radius of the storage medium, the first area being used for simultaneous recording and reproduction, on which data are sequentially recorded while data that have been recorded thereon are reproduced, the second area being used for regular recording and reproduction, on which data not for the simultaneous recording and reproduction are recorded;
generating sequential addresses corresponding to the first area; and
sequentially recording data for the simultaneous recording and reproduction on the first area according the sequential addresses so that the first area becomes a physically continuous area without interposing the second area.

2. The method of recording according to claim 1, wherein the step of generating sequential addresses includes the step of generating sequential addresses that correspond to an outer area on the storage medium so that the first area is allocated outer than the second area with respect to the center of the storage medium.

3. The method of recording according to claim 2, wherein the step of allocating areas includes the step of allocating the first area at 65% or less of an entire recordable area on the storage medium when a ratio of a recording rate to input data rate is 2.5 or less.

4. The method of recording according to claim 2, wherein the data for the simultaneous recording and reproduction are sequentially recorded at constant linear velocity.
